(19) United States
(12) Patent Application Publication
(10) Pub. No.: US 2025/0316756 A1
(43) Pub. Date: Oct. 9, 2025

(54) COMPOSITION

(71) Applicant: Sumitomo Chemical Co., Ltd, Tokyo (JP)

(72) Inventor: Florence Bourcet, Godmanchester (GB)

(73) Assignee: Sumitomo Chemical Co., Ltd, Tokyo (JP)

(21) Appl. No.: 19/171,557

(22) Filed: Apr. 7, 2025

(30) Foreign Application Priority Data
Apr. 8, 2024 (GB) 2405003.1

(51) Int. Cl. H01M 10/0565; H01M 10/0525

(52) U.S. Cl. CPC H01M 10/0565; H01M 10/0525; H01M 2300/0082; H01M 2300/0085

(57) ABSTRACT

A composition comprising a polymer; diethylene glycol diethyl ether; and a compound of formula (I);

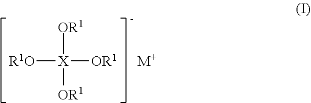

wherein: M⁺ is an alkali metal cation; X is Al or B; and R¹ in each occurrence is independently a substituent wherein two R¹ groups may optionally be linked to form a ring. A gel comprising the composition may be used as an electrolyte in a metal or metal ion battery.

### CROSS REFERENCE TO RELATED APPLICATIONS

This application claims the benefit of and priority to United Kingdom Patent Application No. 2405003.1, filed Apr. 8, 2024, the disclosure of which is incorporated herein by reference in its entirety.

### BACKGROUND

Rechargeable metal ion batteries, in particular lithium-ion metal batteries, are widely used. Lithium metal batteries have also attracted interest due to their high energy density. WO2022/243470 discloses compounds of formula (I):

High ionic conductivity can be achieved by use of a liquid electrolyte, however use of liquid electrolytes, in particular with solvents having a low boiling point, carries a fire risk.

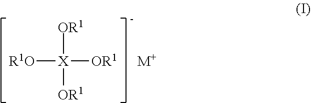

wherein X is Al or B; R¹ is a substituent; and two R¹ groups may be linked to form a ring; and M⁺ is a cation.

US20190140318 discloses a lithium secondary battery having a gel polymer electrolyte between the negative electrode of the battery and a separator, and a liquid electrolyte between the positive electrode of the battery and the separator.

CN115528299 discloses a gel electrolyte for a lithium battery.

US20190190068 discloses a negative electrolyte including: a non-aqueous solvent comprising an ether solvent; a lithium salt having a concentration of about 1 molar to about 6 molar in the non-aqueous solvent; and a crosslinked product of a polymerizable oligomer, wherein the negative electrolyte has a gel or solid form.

### SUMMARY

In some embodiments the present disclosure provides a composition comprising a polymer; diethylene glycol diethyl ether; and a compound of formula (I);

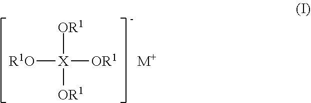

wherein:
M⁺ is an alkali or alkali earth metal cation;
X is Al or B; and
R¹ in each occurrence is independently a substituent wherein two R¹ groups may optionally be linked to form a ring.

Optionally, at least two of the R¹ groups are not linked.

Optionally, each unlinked R¹ is independently selected from the group consisting of
—(C═O)n-C₁₋₂₀ alkyl wherein n is 0 or 1 and one or more non-adjacent C atoms other than a C atom directly bound to O of the borate or aluminate may be replaced with O and one or more H atoms may be replaced with F; C₆₋₂₀ aryl which may be optionally substituted; and C₁₋₂₀ alkylene-C₆₋₂₀ aryl wherein one or more non-adjacent C atoms of the C₁₋₂₀ alkylene other than the C atom bound to O of the aluminate or borate may be replaced with O and one or more H atoms of the C₁₋₂₀ alkylene may be replaced with F, and the C₆₋₂₀ aryl may be unsubstituted or substituted with one or more substituents.

Optionally, none of the R¹ groups are linked.

Optionally, at least 2 of the R¹ groups are linked to form a group R². Optionally, according to these embodiments, R² in each occurrence is independently selected from the group consisting of Ar¹ wherein Ar¹ in each occurrence is independent an optionally substituted C₆₋₂₀ arylene group which may be unsubstituted or substituted with one or more substituents; a bi-arylene group of formula Ar¹—Ar¹ which may be unsubstituted or substituted with one or more substituents; ethylene; propylene; and a group of formula (III):

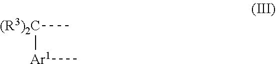

wherein R³ in each occurrence is H, F or a C₁₋₆ alkyl in which one or more H atoms may be replaced with F; and Ar¹ is a C₆₋₂₀ arylene group.

Optionally, the composition comprises one or more further solvents.

Optionally, the further solvents include a solvent selected from C₂₋₁₀ alkylene carbonates and a di(C₁₋₁₀ alkyl) carbonates.

Optionally, the polymer is a fluorinated polymer.

Optionally, the composition is a gel.

Optionally, the composition further comprises a crosslinkable material

Optionally, the composition comprises a crosslinkable monomer.

The present disclosure provides a film comprising a composition as described herein.

The present disclosure provides a crosslinked film comprising a composition as described herein.

The present disclosure provides a method of forming a film as described herein comprising deposition of a solution comprising a composition as described herein onto a surface and heating the deposited solution.

The present disclosure provides a metal battery or metal ion battery comprising a film or a crosslinked film as described herein disposed between an anode and a cathode

### DESCRIPTION OF DRAWINGS

FIG. 1 is a schematic illustration of a secondary metal battery containing an electrolyte as described herein;

FIG. 2A shows Nyquist plots for a cell in which the electrolyte contains DEGDE and a comparative cell;

FIG. 2B shows a magnified region of the Nyquist plot of FIG. 2A; and

FIG. 3 shows a graph of current density and of voltage vs. time for a cell containing a gel electrolyte.

The drawings are not drawn to scale. The drawings are some implementations and examples. While the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. References to a layer “over” another layer when used in this application means that the layers may be in direct contact or one or more intervening layers may be present. References to a layer “on” another layer when used in this application means that the layers are in direct contact. References to an element of the Periodic Table include any isotopes of that element.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

### Electrolyte

The electrolyte described herein is a gel electrolyte containing diethylene glycol diethyl ether (DEGDE), a polymer and a compound of formula (I).

DEGDE's high boiling point (189° C.) means that a fire risk of a battery containing DEGDE is reduced as compared to a battery in which DEGDE is replaced with a lower boiling, more volatile, solvent. The present inventors have surprisingly found that, despite its high boiling point, electrolytes containing DEGDE can have a high ionic conductivity.

The electrolyte containing DEGDE as described herein is a gel electrolyte comprising a polymer.

Exemplary polymers include, without limitation: poly(alkylene oxide), for example poly(ethylene oxide) and poly(propylene oxide); and fluorinated polymers such as PVDF, PVDF-HFP; PMMA; polyacrylonitrile; polycarbonate; polyethylene; polypropylene; poly(vinyl methyl ketone); polyvinylpyrrolidone; polyether ether ketone; polyisoprene; polybutadiene; polystyrene-block-polyisoprene-block-polystyrene; poly(1-vinylpyrrolidone-co-vinyl acetate); polystyrene-block-polybutadiene-block-polystyrene; polystyrene-block-poly(ethylene oxide)-block-polystyrene; co-polymer and mixtures thereof.

The polystyrene-equivalent number-average molecular weight (Mn) measured by gel permeation chromatography of the polymer may be in the range of about 1×10³ to 1×10⁸, and preferably 1×10⁴ to 5×10⁶. The polystyrene-equivalent weight-average molecular weight (Mw) of the polymers described herein may be 1×10³ to 1×10⁸, and preferably 5×10³ to 1×10⁷.

Preferably, the polymer is a fluorinated polymer.

The ion-conducting polymer is suitably a neutral polymer, i.e., not a polymer substituted with ionic groups, and in particular is suitably not a single-ion conducting polymer comprising anionic groups.

In some embodiments, the sole free solvent present in the electrolyte is DEGDE. By “free solvent” as used herein is mean solvent that is not coordinated to the metal ion of the compound of formula (I).

In some embodiments the electrolyte comprises one or more further solvents. Exemplary further solvents include, without limitation, C₂₋₁₀ alkylene carbonates, di(C₁₋₁₀ alkyl) carbonates, for example propylene carbonate, ethylene carbonate, dimethyl carbonate, diethyl carbonate; and linear, branched or cyclic compounds containing two or more ether groups with the exception of DEGDE, for example 1,3-dioxolane, 2,5-dimethoxy tetrahydrofuran, glyme (dimethoxyethane), diglyme, triglyme and tetraglyme; cyclic lactones and mixtures thereof.

The electrolyte may be crosslinked. The crosslinked electrolyte may be formed from an electrolyte precursor containing a crosslinkable material. The crosslinkable material may be a polymer substituted with a crosslinkable group. The crosslinkable material may be a monomer which forms a crosslinked polymer upon polymerisation, for example a diacrylate.

The compound of formula (I) is:

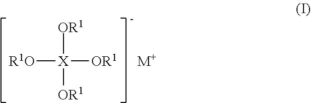

wherein:
X is Al or B;
M⁺ is an alkali or alkali earth metal cation, preferably Li⁺; and
R¹ in each occurrence is independently a substituent wherein two R¹ groups may be linked to form a ring.

Preferably, each R¹ is independently selected from:
—(C═O)n-C₁₋₂₀ alkyl wherein n is 0 or 1 and one or more non-adjacent C atoms other than the C atom directly bound to O of the borate or aluminate (in the case where n is 0) may be replaced with O and one or more H atoms may be replaced with F;
an optionally substituted C₆₋₂₀ aryl; and
C₁₋₂₀ alkylene-C₆₋₂₀ aryl wherein one or more non-adjacent C atoms of the C₁₋₂₀ alkylene other than the C atom bound to O of the borate may be replaced with O and one or more H atoms of the C₁₋₂₀ alkylene may be replaced with F, and the C₆₋₂₀ aryl may be unsubstituted or substituted.

Where present, substituents of the C₆₋₂₀ aryl are preferably and independently selected from substituents R⁵ wherein R⁵ in each occurrence is independently selected from the group consisting of F and C₁₋₁₂ alkyl wherein one or more non-adjacent, non-terminal C atoms of the C₁₋₁₂ alkyl may be replaced with O, S, NR⁴, CO COO or CONR⁴ wherein R⁴ in each occurrence is independently a C₁₋₁₂ hydrocarbyl group, and one or more H atoms of the C₁₋₁₂ alkyl group may be replaced with F.

By “non-terminal C atom” of an alkyl chain as used herein is meant the methyl group at the chain end of a linear alkyl chain or each one of the methyl groups at the chain ends of a branched alkyl group.

A C₁₋₁₂ hydrocarbyl group as described anywhere herein is preferably selected from C₁₋₁₂ alkyl; phenyl; and phenyl substituted with one or more C₁₋₆ alkyl groups.

In the case where none of the R¹ groups are linked, preferably each R¹ independently in each occurrence is a C₁₋₂₀ alkyl group wherein one or more non-adjacent C atoms of the alkyl group, other than the C atom bound to the O atom of the aluminate or borate, may be replaced with O and one or more H atoms of the alkyl group may be replaced with F.

In some embodiments, two pairs of R¹ groups are linked and the compound of formula (I) has formula (II):

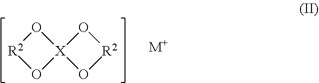

R² in each occurrence is independently a divalent organic group.

Preferably, R² is selected from:
unsubstituted or substituted C₆₋₂₀ arylene;
unsubstituted or substituted C₁₋₂₀ alkylene wherein one or more non-adjacent C atoms other than the C atoms directly bound to O of the borate or aluminate may be replaced with O and one or more H atoms may be replaced with F; and
C₁₋₂₀-alkylene-C₆₋₂₀ arylene wherein one or more non-adjacent C atoms of the C₁₋₂₀ alkylene other than the C atoms bound to O of the borate or aluminate may be replaced with O, the C₁₋₂₀-alkylene is unsubstituted or substituted; and the C₆₋₂₀ arylene is substituted or unsubstituted.

The C₆₋₂₀ arylene may be unsubstituted or substituted with one or more substituents. Preferred substituents, where present, are selected from R⁵ as described above.

R² is preferably selected from: Ar¹ wherein Ar¹ in each occurrence is independent an optionally substituted C₆₋₂₀ arylene group, e.g. 1,2-phenylene, which may be unsubstituted or substituted with one or more substituents; a bi-arylene group of formula Ar¹—Ar¹, for example 2,2′-linked biphenylene which may be unsubstituted or substituted with one or more substituents; ethylene; propylene; and a group of formula (III):

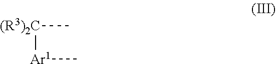

wherein R³ in each occurrence is H, F or a C₁₋₆ alkyl in which one or more H atoms may be replaced with F; and Ar¹ is a C₆₋₂₀ arylene group, preferably unsubstituted or substituted 1,2-phenylene.

In a preferred embodiment, at least one R³, optionally each R³, is a C₁₋₆ perfluoroalkyl group.

Preferably, each Ar¹ of formula (I) is phenylene, more preferably a 1,2-linked phenylene which is unsubstituted or substituted with one or more substituents.

Where present, substituents of Ar¹ are preferably and independently selected from R⁵ as described above

The compound of formula (I) may comprise a solvated M⁺ cation.

Optionally, the electrolyte as present in a battery contains no more than 16 solvent molecules per M+ cation, preferably no more than 12. The solvent/M+ ratio may be as determined from a ¹H NMR spectrum of the electrolyte prior to its incorporation into a battery.

Preferably, a gel as described herein contains at least 9 g of polymer per mole of solvent to obtain a gel. The polymer concentration per mole of solvent is preferably between 9 and 25 g/mol, more preferably between 9 and 17 g/mol.

Optionally, an electrolyte polymer:crosslinkable material (if present) ratio in weight:weight, is between 2:10 to 8:10 preferably 4:10

Optionally, an electrolyte polymer:metal salt ratio in polymer weight:weight of dry salt, is between 10:90 and 40:60, preferably between 15:85 and 30:70.

DEGDE % in the gel is preferably between 10% and 60%, preferably between 15% and 45% by weight of the gel

DEGDE: other solvent ratio weight ratio in the gel is optionally between 1:9 and 3:2, preferably about 2:3 by weight.

“Dry” salt mass as used herein means the mass of the salt without any solvent molecules coordinated to the metal.

The polymer mass in the ratios given herein is the total mass of polymers if the gel contains more than one polymer,

The solvent mass in the ratios given herein is the total mass of solvents if the gel contains more than one solvent,

### Gel Electrolyte Formation

A gel electrolyte may be formed by depositing a solution comprising a composition as described herein onto a surface and evaporating some, but not all, of the solvent present in the solution.

Evaporation is preferably by heating, optionally at a temperature in the range of 30-100° C. Drying temperatures and times may be selected according to the boiling point(s) of the solvent(s) of the solution and the desired quantity of solvent in the gel. The quantity of solvent in the gel may be determined by ¹H NMR spectroscopy of the gel following drying treatment and prior to battery formation.

Optionally, the gel electrolyte is crosslinked following deposition. The deposited solution may comprise a crosslinkable material such as a crosslinkable polymer or a monomer which polymerises to form a crosslinked polymer.

Exemplary groups for forming a crosslinked polymer include, without limitation, epoxy groups and groups containing a reactive carbon-carbon double bond. The reactive carbon-carbon double bond may be a carbon-carbon double bond of a strained cyclic group, for example norbornene or cyclobutene. The reactive carbon-carbon double bond may be an acyclic carbon-carbon double bond, preferably a group of formula —CR⁶═CH₂ wherein R⁶ is H or a substituent, for example a group of a methacrylate or acrylate.

A polymer may be substituted with a crosslinkable group which reacts to crosslink polymer chains.

A monomer may contain two or more crosslinkable groups which react to form a crosslinked polymer.

### Battery

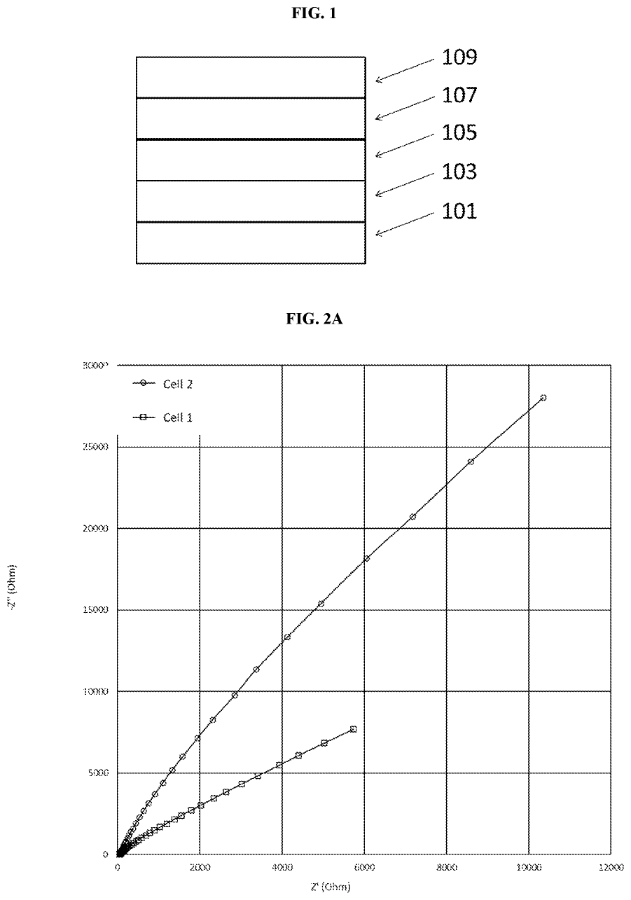

FIG. 1 illustrates a battery. The battery may be a metal battery or a metal ion battery. The metal of the metal battery or metal ion battery is preferably an alkali or alkali earth metal, more preferably an alkali metal, most preferably Li or Na.

The battery comprises an anode current collector 101 in contact with an anode 103 on a surface thereof; a cathode current collector 109 in contact with a cathode 107; and a layer 105 comprising or consisting of an electrolyte as described herein disposed between the anode and cathode.

In some embodiments, layer 105 is a gel layer comprising a polymer; a solvent; and a compound of formula (I).

In some embodiments, layer 105 is a porous separator comprising an electrolyte as described herein absorbed into the porous separator.

In the case of a metal ion battery, the anode comprises an active material, e.g., graphite, for absorption of the metal ions.

In the case of a metal battery, the anode 103 is a layer of metal which is formed over the anode current collector during charging of the battery and which is stripped during discharge of the battery.

The cathode may be selected from any cathode known to the skilled person.

The anode and cathode current collectors may be any suitable conductive material known to the skilled person, e.g. one or more layers of metal or metal alloy such as aluminium or copper.

For simplicity, FIG. 1 illustrates a battery in which the anode and cathode are separated only by a layer comprising or consisting of the electrolyte, however it will be understood that in use a solid-electrolyte interphase will typically form on the anode surface.

In other embodiments, one or more further layers may be disposed between the anode and the electrolyte and/or the cathode and the electrolyte.

### EXAMPLES

### Electrolyte Formation

Poly(ethylene glycol) dimethacrylate (PEGDMA) average Mn 550, containing 80-120 ppm MEHQ as inhibitor, 270-330 ppm BHT as inhibitor was filtered through a short pad of basic alumina in a pipette to obtain 222 mg of unstabilised monomer. 7.5 mg of 1,1′-Azobis (cyclohexanecarbonitrile) (ACHN) was dissolved in 0.888 ml of THF and added to the PEGDMA to give a 200 mg/ml solution of PEGDMA.

PVDF-HFP solutions in acetone, tetrahydrofuran and 1,2-dimethoxyethane were prepared by dissolving PVDF-HFP pellets in the solvent.

Lithium salts 1-3 illustrated below were used.

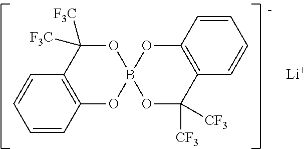

Lithium Salt 1A: 7.9 molecules of PC per molecule of lithium cation
Lithium Salt 1B: 6.0 molecules of PC per molecule of lithium cation

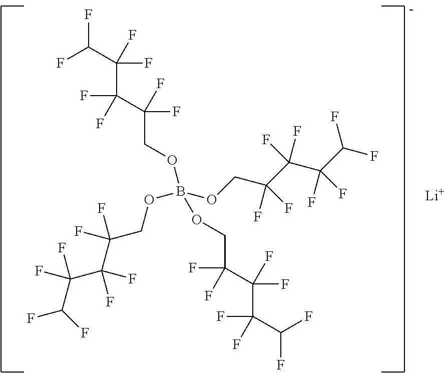

Lithium Salt 2A: 1.9 molecules of PC per molecule of lithium cation
Lithium Salt 2B: 2.4 molecules of PC per molecule of lithium cation

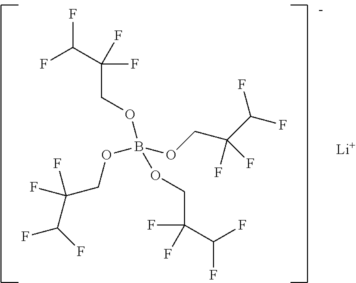

Lithium Salt 3A: 3.1 molecules of PC per molecule of lithium cation
Lithium Salt 3B: 2.8 molecules of PC per molecule of lithium cation

Free-flowing electrolyte solutions were formed by placing into a 2 ml glass vial the following:
One of Compound Examples 1-3
PVDF-HFP solution (100 mg/ml unless stated otherwise)
PEGDMA solution (200 mg/ml unless stated otherwise)
One or more solvents as set out in Table 1 below

| | | | PVDF- | | | | | | | | |
|---|---|---|---|---|---|---|---|---|---|---|---|
| | | Lithium | HFP | | PEGDMA | | | | | | |
| | | salt | solution | PVDF- | solution | PEGDMA | Propylene | | | | |
| | Lithium | mass | volume | HFP | volume | solution | carbonate | DME | THF | DEGDE | Acetone |
| Electrolyte | salt | (mg) | (μl) | solvent | (μl) | solvent | (μl) | (μl) | (μl) | (μl) | (μl) |
| 1 | 3B | 260 | 300 | Acetone | — | — | 95 | — | — | 226 | — |
| 2 | 3A | 362 | 400 | DME | — | — | 87 | 220 | — | — | — |
| 3 | 2A | 143 | 100 | THF | 50 | THE | 82 | — | 154 | — | — |
| 4 | 2B | 276 | 110 | THE | 137.5 | THF | 94 | — | 172.5 | 225 | — |
| 5 | 1A | 362 | 130 | Acetone | 162.5 | Acetone | 69 | — | — | — | 47.5 |
| 6 | 1B | 322 | 90 | Acetone | 112.5 | Acetone | 12 | — | — | 303 | — |
| 7 | 1A | 362 | 130 | Acetone | 162.5 | Acetone | — | — | — | — | 131 |
| 8 | 3B | 226 | 130 | Acetone | 162.5 | Acetone | 177 | — | — | — | 72.5 |
| 9 | 3B | 261 | 100 * | Acetone | 125 ** | Acetone | 115 | — | — | 313 | — |

* 150 mg/ml
**300 mg/ml

### Film Formation

Electrolyte films were formed by drop-casting the solutions using a micropipette onto a stainless steel disk placed on a hotplate set at 30° C. and left for a first period for evaporation of solvents. The first period heating time was selected according to the solvent and desired degree of solvent evaporation. The second period heating time was for crosslinking of PEGDMA. For some solutions, the hotplate temperature was increased and the film was covered with a coin cell top and held at a higher temperature for a second period. Following heating for the first period and optional second period the film was allowed to cool to room temperature.

| | Volume of | First period | Second | Second |
|---|---|---|---|---|
| | electrolyte | (Heating | period | period |
| | solution | time at | temperature | time |
| Electrolyte | (μL) | 30° C., mins) | (° C.) | (mins) |
| 1 | 200 | 45 | — | — |
| 2 | 200 | 12 | — | — |
| 3 | 200 | 30 | 70 | 60 |
| 4 | 200 | 30 | 70 | 60 |
| 5 | 200 | 30 | 70 | 60 |
| 6 | 215 | 30 | 80 | 60 |
| 7 | 200 | 30 | 70 | 60 |
| 8 | 200 | 30 | 70 | 60 |
| 9 | 207 | 30 | 80 | 60 |

### Cell General Method

Cells 1-9 were made using gels formed from Solutions 1-9, respectively.

For each of the stainless steel disks carrying a gel film as described above, the gel film was cut into a 9 mm diameter circle using a manual disc cutter (purchased from Cambridge Energy Solutions) and a 360 micron thick silicone stencil (purchased from Silex Silicones), shaped as a disk of 16 mm diameter with a circular hole of 9 mm diameter cut in its middle was placed to surround the gel film.

A saturated solution of silver nitrate in dimethyl carbonate was reduced with small pieces of metallic lithium foil, by stirring overnight using a magnetic stirrer bar at RPM>900. The reaction resulted in the formation of a finely dispersed, grey-black powder that was collected and dried in a Petri dish at room temperature. An ETFE mesh was dipped into the dried grey-black powder in the Petri dish and was gently polished onto the surface of a pre-polished lithium disk without native oxide layer. This treatment resulted in a colour change due to the formation of a smooth, thin layer of silver-lithium alloy on the surface of the lithium disk.

Cells were fabricated in a rigorously dry and oxygen-free Argon gas-filled MBraun glovebox using casings purchased from Cambridge Energy Solutions.

2032-type coin cells were formed by inserting a stainless-steel spacer in a coin cell bottom, followed by, in sequence, a steel disk carrying the dried gel and silicone spacer, the Ag-Li modified lithium disk with the modified surface contacting the gel, a stainless steel spacer, a wave spring and a coin cell top. The assembled structure was crimped.

### Results

Electrochemical Impedance Spectroscopy (EIS) measurements were conducted at room temperature. Impedances were taken over a frequency range of 1 Hz to 1 MHz, with an amplitude of 5 mV.

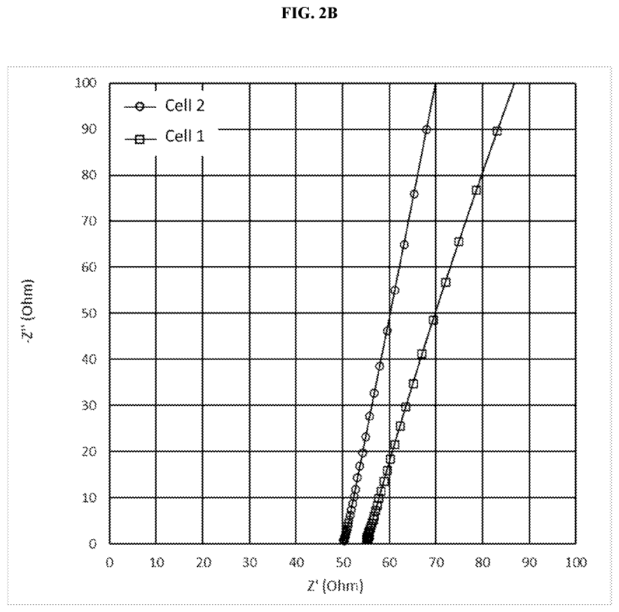

Nyquist plots for Cell 1 (containing DEGDE) and Cell 2 (containing DME) are shown in FIG. 2A, with magnification in FIG. 2B.

Each cell was fitted with a a R-(R-Wi, CPE) equivalent circuit. The first R circuit component was taken as the impedance of the electrolyte.

The limiting current density, i.e., the highest unidirectional current density that a given electrolyte material can sustain over an extended period of time, was determined by measuring the voltage as a function of time, during successive plating and stripping cycles at stepwise increased current densities.

The measurements were performed with coin cells, using the Arbin battery testing system (Arbin Instruments).

The Lithium plating and stripping cycles were carried out as follows (FIG. 4):
1. Application of an initial plating current (which corresponds to current density of 0.94 mA/cm2) for 1 hour, followed by
2. Application of an initial stripping current (which corresponds to current density of −0.94 mA/cm2) for 1 hour.
3. Following this, both steps (1) & (2) were repeated five times in total.
4. Next, the applied “plating” & “stripping” currents were increased to achieve 0.24 mA/cm2 increase in the corresponding current density.
5. Following this, the cell was cycled five times at this higher level.
6. Steps (4) & (5) were repeated until measured voltage started to be unstable.

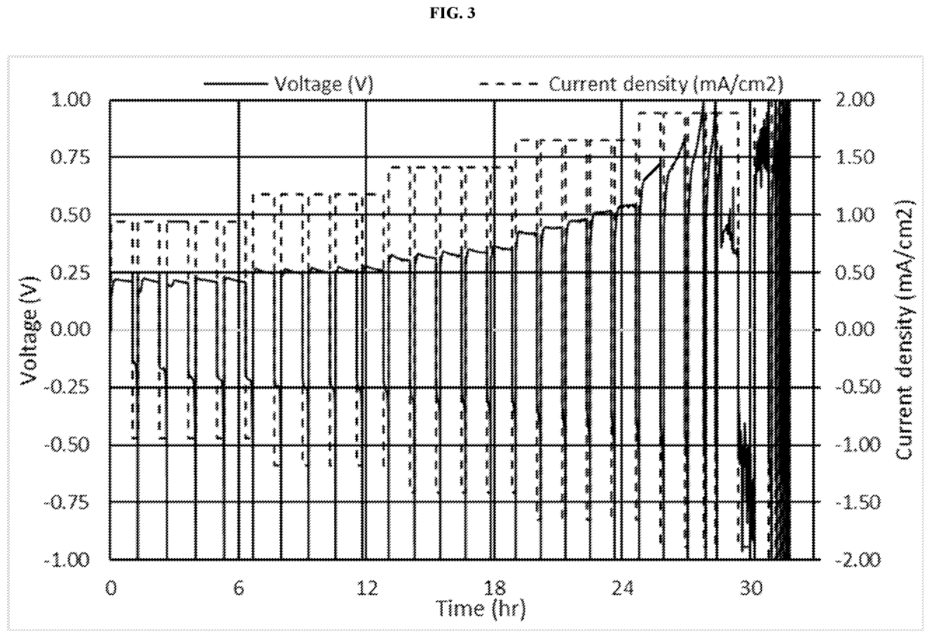

For illustration, the limiting current measurement for the cell containing Gel Electrolyte Film 1 shown in FIG. 3. Above the current density of 1.7 mA/cm2, voltage started to increase rapidly in each consecutive plating cycle and some instability appeared. Based on this, the limiting current density for this gel was determined to be 1.7 mA/cm2.

Tables 2 to 5 show comparison of gel with and without DEGDE.

Including DEGDE in gel electrolyte formulations led to good performances of these electrolytes in devices, even when used in place of a low boiling solvent.

TABLE 2
Lithium salt 3:PVDF-HFP mass ratio of 85:15

| | Solvent 1 | | Conductivity | Limiting current |
|---|---|---|---|---|
| Cell | (PC/Li⁺) | Solvent 2 | (mS/cm) | density (mA/cm²) |
| 2 | 5.5 | 2.1 DME/Li⁺ | 1.3 | 1.56 |
| 1 | 5.9 | 3.5 DEGDE/Li⁺ | 1.4 | 1.73 |

TABLE 3
Lithium salt 2:PVDF-HFP mass ratio of
85:15 and PVDF-HFP:PEGDMA ratio is 4:10

| | Solvent 1 | Solvent 2 | Conductivity |
|---|---|---|---|
| Gel | (PC/Li⁺) | (DEGDE/Li⁺) | (mS/cm) |
| 3 | 8.6 | — | 0.2 |
| 4 | 5.7 | 4.1 | 0.8 |

TABLE 4
Lithium salt 1:PVDF-HFP mass ratio of
76:24 and PVDF-HFP:PEGDMA ratio is 4:10

| | Solvent 1 | Solvent 2 | Conductivity | Limiting current |
|---|---|---|---|---|
| Gel | (PC/Li⁺) | (DEGDE/Li⁺) | (mS/cm) | density (mA/cm²) |
| 5 | 9.4 | — | 0.8 | — |
| 6 | 6.2 | 4.8 | 1.8 | 1.54 |
| 7 | 7.9 | 3.1 | 1.1 | — |

TABLE 5
Lithium salt 3:PVDF-HFP mass ratio of 76.5:23.5
and PVDF-HFP:PEGDMA ratio is 4:10

| | Solvent 1 | Solvent 2 | Conductivity | Limiting current |
|---|---|---|---|---|
| Gel | (PC/Li⁺) | (DEGDE/Li⁺) | (mS/cm) | density (mA/cm²) |
| 8 | 10.2 | — | 0.4 | — |
| 9 | 5.8 | 4.0 | 1.2 | 1.60 |

The number of solvent molecules per lithium cation in Lithium Salts 1-3 as set out in Tables were calculated from integration of ¹H NMR peaks. The soluble parts of the gels were dissolved in DMSO-d6. It was assumed for the calculations that two aromatic ligands surrounded one lithium cation or four aliphatic ligands surrounded one lithium cation.

What is claimed is:

1. A composition comprising a polymer; diethylene glycol diethyl ether; and a compound of formula (I); 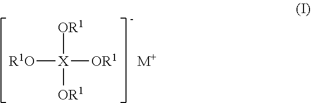
wherein:
M⁺ is an alkali or alkali earth metal cation;
X is Al or B; and
R¹ in each occurrence is independently a substituent wherein two R¹ groups may optionally be linked to form a ring.

2. The composition according to claim 1 wherein at least two of the R¹ groups are not linked.

3. The composition according to claim 2 wherein each unlinked R¹ is independently selected from the group consisting of
—(C═O)n-C₁₋₂₀ alkyl wherein n is 0 or 1 and one or more non-adjacent C atoms other than a C atom directly bound to O of the borate or aluminate may be replaced with O and one or more H atoms may be replaced with F; C₆₋₂₀ aryl which may be optionally substituted; and C₁₋₂₀ alkylene-C₆₋₂₀ aryl wherein one or more non-adjacent C atoms of the C₁₋₂₀ alkylene other than the C atom bound to O of the aluminate or borate may be replaced with O and one or more H atoms of the C₁₋₂₀ alkylene may be replaced with F, and the C₆₋₂₀ aryl may be unsubstituted or substituted with one or more substituents.

4. The composition according to claim 2 wherein none of the R¹ groups are linked.

5. The composition according to claim 1 wherein at least 2 of the R¹ groups are linked to form a group R².

6. The composition according to claim 5 wherein R² in each occurrence is independently selected from the group consisting of Ar¹ wherein Ar¹ in each occurrence is independent an optionally substituted C₆₋₂₀ arylene group which may be unsubstituted or substituted with one or more substituents; a bi-arylene group of formula Ar¹—Ar¹ which may be unsubstituted or substituted with one or more substituents; ethylene; propylene; and a group of formula (III): 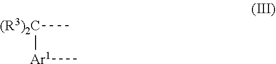
wherein R³ in each occurrence is H, F or a C₁₋₆ alkyl in which one or more H atoms may be replaced with F; and Ar¹ is a C₆₋₂₀ arylene group.

7. The composition according to claim 1 wherein the composition comprises one or more further solvents.

8. The composition according to claim 7 wherein the further solvents include a solvent selected from C₂₋₁₀ alkylene carbonates and a di(C₁₋₁₀ alkyl) carbonates.

9. The composition according to claim 1 wherein the polymer is a fluorinated polymer.

10. The composition according to claim 1 wherein the composition is a gel.

11. The composition according to claim 1 wherein the composition further comprises a crosslinkable material.

12. The composition according to claim 1 wherein the composition comprises a crosslinkable monomer.

13. A film comprising a composition according to claim 1.

14. A crosslinked film comprising a composition according to claim 1.

15. A method of forming a film according to claim 13 comprising deposition of a solution comprising a composition onto a surface and heating the deposited solution wherein the composition comprises a polymer; diethylene glycol diethyl ether; and a compound of formula (I); 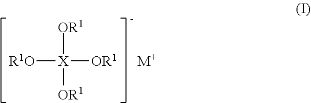
wherein:
M⁺ is an alkali or alkali earth metal cation;
X is Al or B; and
R¹ in each occurrence is independently a substituent wherein two R¹ groups may optionally be linked to form a ring.

16. A metal battery or metal ion battery comprising a film according to claim 13 disposed between an anode and a cathode.

17. A metal battery or metal ion battery comprising a crosslinked film according to claim 14 disposed between an anode and a cathode.
